(19) United States
(12) Patent Application Publication
(10) Pub. No.: US 2007/0143674 A1
(43) Pub. Date: Jun. 21, 2007

(54) LDAP based scan templates

(75) Inventors: Brenda Daos, Mission Viejo, CA (US); Harpreet Singh, Orange, CA (US); Vincent Wu, Irvine, CA (US); Nancy Yip, Irvine, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/313,095

(22) Filed: Dec. 20, 2005

(51) Int. Cl. G06F 15/00

(52) U.S. Cl. 715/530

(57) ABSTRACT

A system and method for sharing updated document templates. A user first selects whether to request a desired document processing operation involving one or more stored scan templates or to modify one of the stored templates. The document scan templates are stored on an associated storage, with each scan template including schema data. The schema data represents attributes associated with the corresponding template. When the user requests a document processing operation, a list of templates associated with the operation are retrieved and displayed to the user. The user then selects the desired template, inputs modification data, and the document processing device performs the selected operation on the updated template. When the user elects to modify a template, the user opens the schema associated therewith, inputs the modifications, and stores the template in the template storage for use by devices on the network. Creation of a new template requires the user to input schema data, attributes and classes, and then save the new template in the template storage.

### BACKGROUND OF THE INVENTION

This invention is directed to a system and method for sharing updated template documents. In particular, this invention is directed to a system and method for sharing and updating document templates between document processing devices on a network.

Document processing devices, such as multifunctional peripheral devices, often include a template function, wherein selected templates or forms are stored in an associated data storage medium for use by users of the device. For example, a purchase order template may be stored in the associated data storage medium of a document processing device for use by the sales department. A user would access the template and enter the required information via any suitable means, and then transmit the completed template for selected document processing operations. Large corporate environments or computer networks generally are comprised of multiple document processing devices and these devices are placed in different locations. Typically a template stored on an associated data storage medium of one document processing device is not available for use by another document processing device. Therefore, a user of document processing device in the marketing department of a corporation would not be able to access the templates stored on a document processing device located in the sales department of the corporation.

One solution would be to transfer the desired template from the document processing device in the sales department to the document processing department in the marketing department. However, once a template is installed on multiple document processing devices, any modification to the template requires that the template be modified on each document processing device on which it is installed. This is a very time consuming process and prone to errors if the template is not updated correctly in each document processing device. There is a need for a system and method for updating templates between document processing devices on a network

The subject invention overcomes the above-noted problems and provides a system and method for sharing updated document templates.

### SUMMARY OF THE INVENTION

In accordance with the present invention, there is provided a system and method for sharing updated document templates.

Further, in accordance with the present invention, there is provided a system and method for updating templates between document processing devices on a network.

Still further, in accordance with the present invention, there is provided a system and method for sharing and updating document templates wherein the templates may be accessed on any document processing device on the network.

Still further, in accordance with the present invention, there is provided a system and method for sharing and updating document templates wherein the template are maintained in a central location or repository.

Still further, in accordance with the present invention, there is provided a system for sharing updated document templates. The system comprises a template storage adapted for storing a plurality of document scan templates, each scan template including schema data representative of attributes associated therewith and means adapted for receiving a plurality of scan templates into the template storage. The system further comprises a network interface and means adapted for receiving a scan template request via the network interface. The system also includes means adapted for selecting one of the plurality of scan templates in the template storage in accordance with a received scan template request and means adapted for communicating a selected one of the plurality of scan templates to at least one selected document processing device via the network interface. The system further includes means adapted for receiving modification data representative modification of a selected document scan template in the template storage, means adapted for selectively modifying schema data associated with the selected document scan template in accordance with the modification data, and means adapted for storing modified schema data in the template storage.

Still further, in accordance with the present invention, there is provided a method for sharing updated document templates. The method comprises the steps of storing a plurality of document scan templates, wherein each scan template including schema data representative of attributes associated therewith and receiving a plurality of scan templates into the template storage. The method further comprises receiving a scan template request via a network interface, selecting one of the plurality of scan templates in the template storage in accordance with a received scan template request. The method also includes the step of communicating a selected one of the plurality of scan templates to at least one selected document processing device via the network interface and receiving modification data representative modification of a selected document scan template in the template storage. The method further includes the steps of selectively modifying schema data associated with the selected document scan template in accordance with the modification data and storing modified schema data in the template storage.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flowchart illustrating a method for modifying the document templates in accordance with the present invention;

FIG. 3 is a flowchart illustrating a method for accessing a document template directly from a document processing device in accordance with the present invention; and

FIG. 4 is a flowchart illustrating a method for accessing a document template from a browser in accordance with the present invention.

### DETAILED DESCRIPTION OF THE PREFERRED EMBODIMENT

This invention is directed to a system and method for sharing updated template documents. In particular, this invention is directed to a system and method for sharing and updating document templates between document processing devices on a network. The system and method of the present invention allows the templates to be accessed on any document processing device on the network and to be maintained in a central location or repository. In the preferred embodiment, as described herein, the document processing device is suitably an image generating device. Preferably, the image generating device is a multifunctional peripheral device, capable of providing scanning, copying, facsimile, printing, document management, document storage, electronic mail, and other functions to a user. In the preferred embodiment, the subject invention includes reference to a directory service program that enables applications to find, use, and manage directory resources, such as usernames, network peripherals, permissions, and the like, in a distributed computing environment. More preferably, the directory service program is suitably capable of integrating domain name server/services as well as capable of interoperability with lightweight directory access protocols. Those skilled in the art will appreciate that the subject invention is equally applicable to any directory service program known in the art, including, without limitation, Active Directory™ directory service program by Microsoft Corporation, and the like.

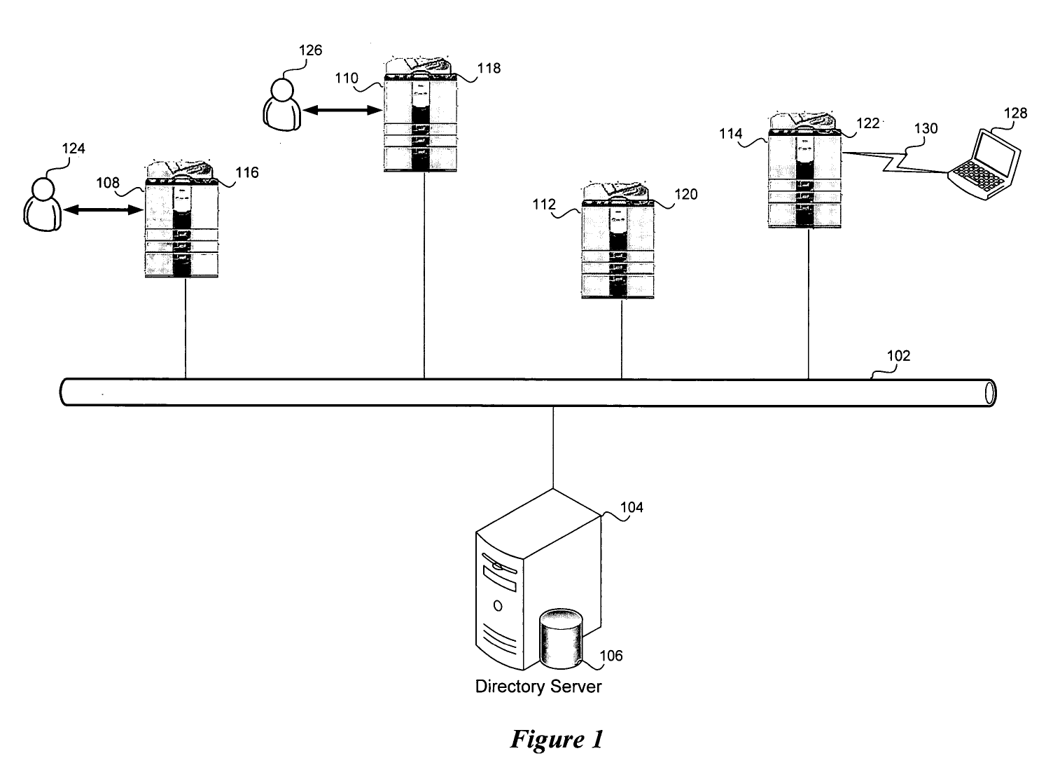

Referring now to FIG. 1, there is shown a block diagram illustrating a system 100 in accordance with the present invention. As depicted in FIG. 1, the system 100 includes a distributed computing environment, the computer network 102. It will be appreciated by those skilled in the art that the computer network 102 is any computer network known in the art suitably adapted to carry electronic data communications between two or more electronic devices. In accordance with the present invention, the system 100 is advantageously capable of implementation on any such computer network known in the art, including, but not limited to, a personal area network, a local area network, a wide area network, and the like. In the preferred embodiment, the computer network 102 is representative of a local area network. More preferably, the computer network 102 is a corporate network, employing one or more security features, such as unique password/username combinations, thereby restricting access to the network 102. Further in accordance with the present invention, the computer network 102 is accessible via a wide area network, such as the Internet, whereby authenticated remote users are able to access the resources contained on the computer network 102.

The system 100 further includes a directory server 104 communicatively coupled to the computer network 102. It will be understood by those skilled in the art that the directory server 104 is any computing device, software, or combination thereof, known in the art capable of providing a structured repository of information regarding all software, hardware, corresponding rights and policies, which are implemented on the computer network 102. In the preferred embodiment, the directory server 104 includes an associated data storage 106, suitably adapted to store database information, directory information, and the like. As will be understood by those skilled in the art, the data storage 106 is any mass storage device known in the art, including, without limitation, magnetic hard disk drives, flash memory, optical storage, or any combination thereof. Preferably, the data storage 106 includes data representative of one or more document templates, such as, for example and without limitation, reports, purchase orders, receipts, and the like. In one embodiment of the present invention, the data storage 106 further employs a lightweight directory access protocol (LDAP) server. Although not shown in FIG. 1, the skilled artisan will appreciate that the directory server 104 is advantageously equipped with a user-interface, thereby enabling a system administrator to directly interface with the server 104, and administer to the network 102 thereon. Furthermore, the skilled artisan will appreciate that a system administrator is also able to directly interface with the server 104 using a suitable electronic device (not shown), via the computer network 102.

In addition to the foregoing, the system 100 includes one or more network peripheral devices, illustrated in FIG. 1 as the document processing devices 108, 110, 112, and 114. As depicted in FIG. 1, the document processing devices 108-114 are multifunction peripheral devices, suitably adapted to provide a variety of document processing services, such as, for example and without limitation, scanning, copying, facsimile, printing, and the like. Suitable commercially available image generating devices include, but are not limited to, the Toshiba e-Studio Series Controller. In one embodiment, the document processing devices 108-114 are suitably equipped to receive a plurality of portable storage media, including without limitation, Firewire, USB, SD, MMC, XD, Compact Flash, Memory Stick, and the like. Other peripheral devices, including, without limitation, user devices such as personal data assistants, desktop computers, printers, facsimile machines, scanners, copiers, laptop computers, and other non-administrative configured devices, are also considered peripheral devices in accordance with the present invention.

Each of the document processing devices 108, 110, 112, and 114 further include an associated user interface 116, 118, 120, and 122, respectively. In accordance with the preferred embodiment of the present invention, the user-interfaces 116-122 are any interactive means of communication between a user and the associated document processing device 108-114 known in the art, including, without limitation, a touch screen display, an LCD display, an alphanumeric keypad, a function specific tactile input scheme, or any combination thereof. Those skilled in the art will appreciate that an associated user is advantageously able to directly interact with the document processing devices 108-114 via the associated user-interfaces 116-122. Further in accordance with the present invention, the system 100 includes one or more associated users, illustrated in FIG. 1 as the user 124 accessing the document processing device 108 and the user 126 accessing the document processing device 110. It will be appreciated by those skilled in the art that the incorporation of users 124 and 126 are for illustration purposes only, and user devices, such as desktop computers and the like, are equally capable of interacting with the networked document processing devices 108-114, without departing from the scope of the present invention.

FIG. 1 further illustrates a remote client device 128, in data communication with the document processing device 114, via the communications link 130. As will be understood by those skilled in the art, the communications link 130 is any suitable channel of data communications known in the art including, but not limited to wireless communications, for example and without limitation, Bluetooth, WiMax, 802.11a, 802.11b, 802.11g, 802.11(x), infrared, optical, or any suitable wireless data transmission system, or wired communications known in the art. Preferably, the communications link 130 is the Internet and a user associated with the remote client device 128 interacts with the document processing device 122 via a suitable web portal, such as a secure web browser. The associated user of the client device 128 logs into the computer network 102, is authenticated in accordance with the protocols set forth on the server 104, and is provided access to the computer network 102 thereupon.

The present invention enables the use of document templates by users 124, 126 and the remote client device 128, in accordance with the methods described in greater detail below. In operation, a template is generated by an administrator or authorized user based upon Active Directory/LDAP principles. Thus, the template is made accessible to each document processing device 108-114 associated with the computer network 102. To facilitate this use, an authorized user, hereinafter referred to as an administrator, first logs onto the directory server 104 via any means known in the art. Preferably, the directory server 104 functions as an authentication server to authenticate the administrator, so as to verify the authority of the administrator to effectuate changes to the network 102. It will be understood by those skilled in the art that the authentication server referenced above is capable of being implemented as software on the server 104, or any of the networked devices 108-114 connected to the network 102.

When generating a new document template in accordance with the present invention, the administrator first selects a class associated with the schema being input. Following class selection, the administrator associates the desired attributes, as will be understood by those skilled in the art. The directory server 104 then generates a default template in accordance with the input class and attributes selected by the administrator. The new template is then stored on the directory server 104 for future retrieval by a document processing device, when requested by an associated user. When the administrator desires to modify schema entries in the data storage 106, i.e., to modify a previously stored template, a list of stored templates is displayed to the administrator. The administrator then selects from among the list of displayed templates the template to be modified. The schema is then opened for modification by any means known in the art. The administrator then modifies the attributes associated with the schema to reflect the desired changes. The modified schema, or template, is then stored in the data storage 106 for further use by requesting users.

In accordance with one aspect of the present invention, a user 124 is capable of requesting a template via the user-interface 116 of an associated document processing device 108. The user 124 first selects a document processing operation via a graphical user interface displayed on the user-interface 116 of the document processing device 108. The document processing device 108 then retrieves, from the directory server 104, those templates corresponding to the selected document processing operation. The retrieved templates are then displayed to the user, via the user-interface 116, whereupon the user selects the template desired. Using the user-interface 116, the user 124 inputs modification data corresponding to fields, or the like, which are then used to complete the document template. For example, when using a purchase order template, the user 124 inputs the vendor information, product information, and any other relevant information, via a series of prompts provided on the user-interface 116. The completed purchase order template is then processed in accordance with the selected document processing operation. The user 124 is then given the option to select another document processing operation, and thereupon the same or a different associated template, or to end the session.

In another aspect of the present invention, the system 100 provides for a remote client device 128 to access the templates available on the directory server 104. A user associated with the remote client device 128 suitably initiates a session via web portal, or web browser, application running on the remote device 128. The user inputs authentication information, which is then verified by the network 102 authentication protocols. From the authentication information provided by the user, the rights and privileges associated with the user's logon information are retrieved and used to determine whether the user is authorized to modify schema on the directory server 104, to use templates stored on the data storage 106 associated with the server 104, or is rejected by the system 100 from accessing the document processing devices 108-114 and other peripherals on the network 102. It will be appreciated by those skilled in the art that the network 102 is capable of implementing various security precautions, such as a firewall, secure data connections, and the like, so as to prevent an unauthorized user from accessing the network 102 resources via the remote client device 128.

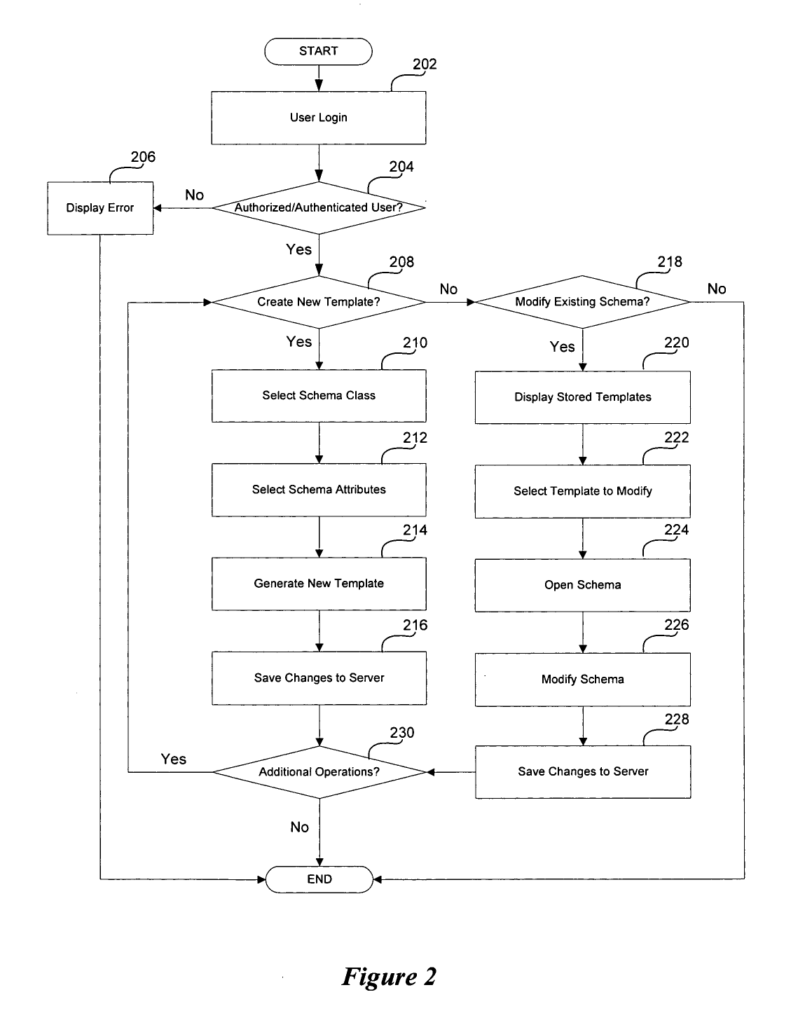

To remotely request a document processing operation, the user, via the associated web browser, selects a document processing operation on the designated document processing device 114. The document processing device 114 then retrieves those templates associated with the selected document processing operation and sends a list to the remote client 128, which is then displayed to the user. The user selects the desired template and inputs the modification data required to complete the template. The template is then used to complete the requested document processing operation on the document processing device 114. When the user desires to modify an existing template, i.e., modify the schema attributes associated with a particular document template stored in the database of the data storage 106, the templates stored thereon are displayed to the user via the web browser of the remote client device 128. From this listing of templates, the user selects the template for which modification is desired. The selected template schema is then opened for modification at the remote client device 128. The remote user is then able to modify the attributes to reflect the desired template changes. The modified schema is then saved and stored on the associated data storage 106 of the directory server 104, thereby making the modified template available to each of the document processing devices 108-114 of the computer network 102. The foregoing system will better be understood in conjunction with the flowcharts of FIGS. 2, 3, and 4, described hereinafter.

Turning now to FIG. 2, there is shown a flowchart 200 illustrating an administrator creation/modification of document templates in accordance with the present invention. As shown in FIG. 2, the flowchart 200 begins at step 202, wherein the user logs onto the directory server 104 via any means known in the art. Preferably, the user is an administrator, and provides a unique user identification and corresponding password, or other authentication information. At step 204, the authentication information is verified to authenticate the administrator, thereby enabling access to the schema stored on the directory server 104. When the administrative login fails at step 204, flow proceeds to step 206, whereupon an error message is displayed to the user and the operation terminates. Once the administrator has been authenticated, flow proceeds to step 208 for a determination whether the administrator has selected to create a new template or to modify the schema associated with an existing template.

Upon a determination at step 208 to generate a new template, flow proceeds to step 210, at which the administrator selects the class of the schema of the new template. The administrator then selects the attributes associated with the new template at step 212. It will be appreciated by those skilled in the art that the use of schema, class, attribute, and the like, as used herein, is understood in the art to represent terms and data structures associated with directory services. Following input by the administrator of the class and attributes, which include template construction data, a new default template is generated at step 214. The administrator then initiates a save process whereupon the newly generated template is stored on the associated data storage 106 of the directory server 104 at step 216. Flow then proceeds to step 230, wherein a determination is made whether the administrator desires additional operations. When no additional operations are selected, the operation terminates. When the administrator desires further operations in accordance with the present invention, flow returns to step 208, whereupon a determination is made whether the desired operation is the creation of a new template.

When, at step 208, the determination is negative, i.e., that new template creation is not selected by the administrator, flow proceeds to step 218, wherein a determination is made whether the administrator desires to modify an existing template schema. The stored schema are then retrieved and displayed to the administrator at step 220. In accordance with the present invention, the administrator is able to view the list via an associated administrative device, a user-interface associated with the directory server 104, and the like. The administrator then selects, at step 222, the schema to modify, upon which selection flow proceeds to step 224. At step 224, the selected schema is opened using any suitable editing application known in the art. The administrator then modifies the attributes, data, and other template data of the template at step 226. The modified template is then stored on the data storage 106 associated with the directory server 104 at step 228. Flow then proceeds to step 230, wherein a determination is made whether additional modification or template creation operations are desired. When no further operations are desired, the administrative session is terminated. When additional operations are desired by the administrator, flow returns to the determination of the type of operation at step 208.

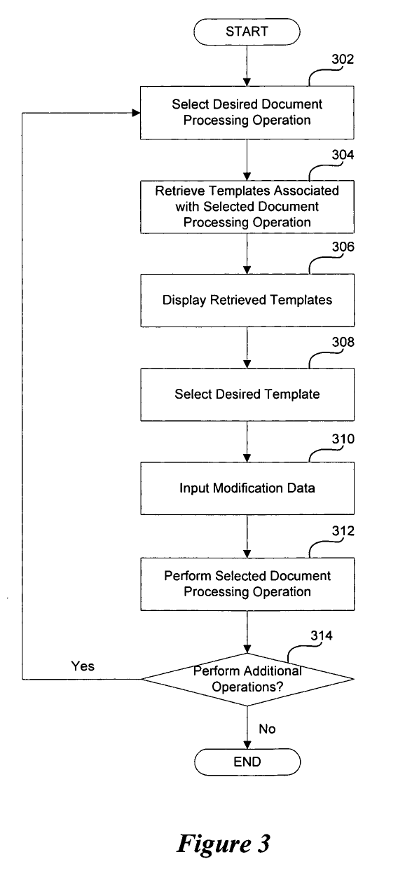

In accordance with the present invention, a walkup user 124 is advantageously capable of using the templates stored on the associated storage 106 via the user-interface 116 of the document processing device 108. To illustrate this interaction, FIG. 3 depicts a flowchart 300 showing a method for accessing a stored template by a walkup user to a document processing device. It will be understood by those skilled in the art that the use of the user 124 and document processing device 108 herein is for purposes of illustrating the method embodied in flowchart 300 and should not be used to constrain the instant invention. Beginning at step 302, a user 124 at the user-interface 116 selects a desired document processing operation to be performed by the associated document processing device 108. Preferably, the selected document processing operation has one or more stored templates associated therewith. Once the user 124 has selected the desired operation, flow progresses to step 304, wherein the templates associated with the selected document processing operation are retrieved from the data storage 106 of the directory server 104 by the document processing device 108 over the computer network 102.

The retrieved template documents are then displayed to the user 124 at step 306 via the associated user-interface 116. Preferably, the templates are displayed in a graphical user interface being displayed on a touch screen interface operatively coupled to the document processing device 108. The user 124, via the user-interface 116, selects a template from the listing of available templates for further use in conjunction with the selected document processing operation. For example, if the user 124 selects the print operation, the document processing device 108 retrieves those templates stored on the server which are associated with the print operation. From that list, the user 124 selects the purchase order template, whereupon the template is displayed to the user and the user is prompted, via the user-interface 116, to input data to complete the template. The user 124 then inputs the modification data into the template via the associated user-interface 116 at step 310. The skilled artisan will appreciate that the modification data input by the walkup user 124 suitably includes, but is not limited to, words, numbers, characters, figures, and the like, which are required to complete a previously created document template, resulting in a completed document. Thus, the user 124 inputs the name of the vendor, other vendor information, service or product description, and the like. It will be appreciated by those skilled in the art that other means of inputting data so as to complete the template are equally capable of being employed, such as barcode scanners, scanners, and the like, in addition to the user-interface 116.

Following completion of the modification data input, flow proceeds to step 312, wherein the document processing device 102 performs the selected document processing operation on the selected modified template. At step 314, a determination is made whether any additional document processing operations have been requested by the walkup user 124. When no additional operations have been requested, the document processing device 108 ends operations and the method terminates. When the user 124 desires the completion of one or more additional document processing operations, flow returns to step 302, whereupon the user 124 is prompted, via the associated user interface 116, to select a document processing operation to be performed by the document processing device 108.

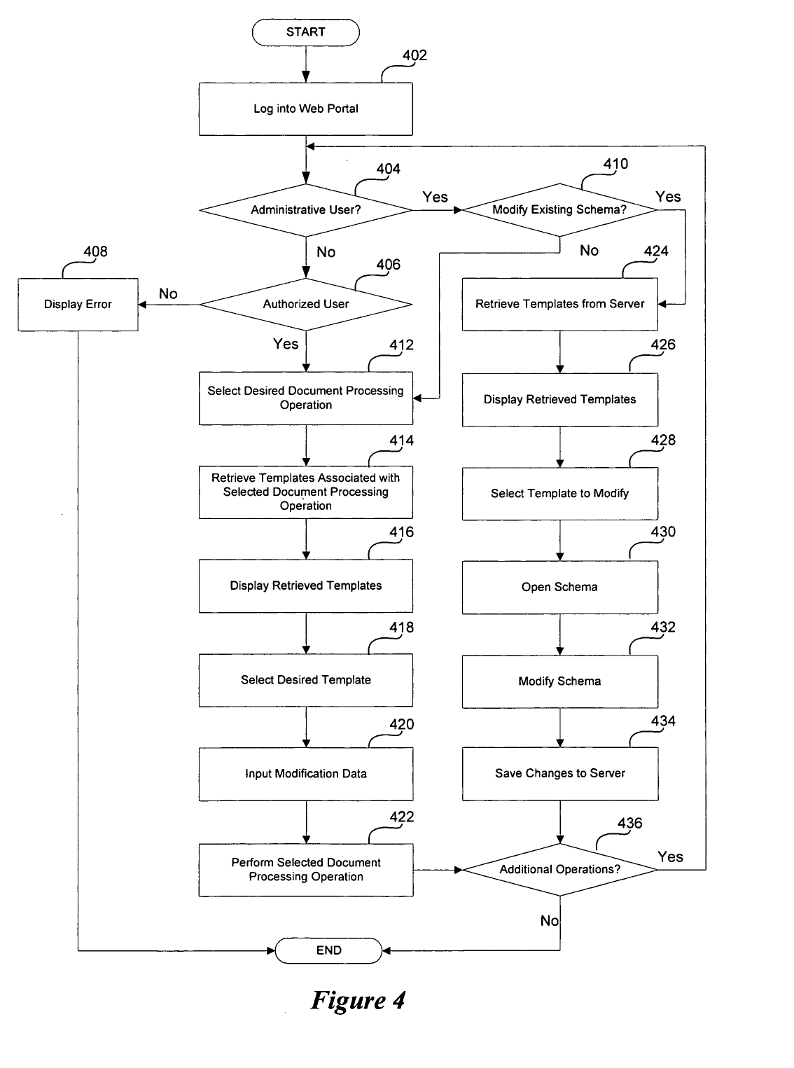

The present invention further enables a remote user, such as the remote client device 128, to interact with a document processing device 114 via a suitable communications link 130, such as the Internet. For purposes of explanation of the flowchart 400 of FIG. 4, the terms “user” and “remote client device” each refer to a remotely situated user accessing the network 102 via co-located client computer. Further in accordance with the present invention, the remote client device 128 is advantageously able to request document processing operations corresponding to those requested by the walkup user 124, as well as selectively modify templates on the server 104, when the user at the remote client device 128 is verified as an administrator. Turning now to FIG. 4, there is shown a flowchart 400 illustrating a method for remotely accessing a document template.

Beginning at step 402, a user logs onto a web portal to securely connect the remote client device 128 to the document processing device 114. Preferably, a secure connection is established via the communications link 130, whereby secure transmission of data between the remote client device 128 and the document processing device 114 is enabled. More preferably, the user logs onto the web portal using a web browser application associated with the remote client device 128. In accordance with the present invention, the logon information, such as a user identification and password are used to authenticate the user against authentication data stored on the directory server 104. Once logged onto the network 102, via the communications link 130, a determination is made at step 404 whether the logged on user is an administrative user. When the user is not an administrative user, flow proceeds to step 406, wherein a determination is made whether the user is authorized to use the document processing device 114 from the remote location. When the user is not authorized, flow proceeds to step 408, wherein an error message is returned to the user and the connection is terminated.

When the user logged onto the system is an authorized user, but is not an administrator, flow proceeds to step 412, wherein the remote user selects a desired document processing operation to be performed by the document processing device 114. Following selection of the desired document processing operation, the document processing device 114 retrieves at step 414, from the data storage 106 associated with the directory server 104, templates associated with the requested document processing operation. The retrieved templates are then displayed on the remote client device 128 web browser at step 416. From the web browser, the user selects a desired document template at step 418. Using the web browser interface of the remote client device 128, the user inputs modification data corresponding to the data required to complete the template, or alternatively, to complete the template to the level desired by the remote user at step 420. The document processing device 114 then performs the selected document processing operation on the modified template at step 420. Flow then proceeds to step 436, wherein a determination is made whether the remote user desires to request any additional document processing operations. When no additional operations are desired, the connection is terminated. When the remote user desires to request additional document processing operations, flow returns to step 404, for a determination whether the user is authorized in an administrative capacity. Operations continue thereon as set forth above.

Returning to step 404, when it is determined that the remote user at the remote client device 128 is an administrator, or a user authorized in an administrative capacity, flow proceeds to step 410, wherein a determination is made whether the administrative user desires to modify a template. When the administrative user does not desire to remotely modify template schema, flow proceeds to step 412, wherein the administrative user selects a desired document processing operation. The document processing device 114 then retrieves the templates associated with the selected document processing request from the associated data storage 106 at step 414. The retrieved templates are then displayed on the remote client device 128 at step 416, whereupon the administrative user selects a template from the list at step 418. Using the remote client device 128 web browser, the administrative user inputs modification data required to complete the template at step 420. The completed template is then subjected to the selected document processing operation at step 422, whereupon a determination is made at step 436 whether the administrative user desires any additional operations. When no additional operations are desired, the session terminates. When additional operations are desired, flow returns to step 404, and operations continue thereon.

Returning to step 410, when the administrative user desires to modify template schema, flow proceeds to step 424, wherein the schema entries on the directory server 104 corresponding to the templates are retrieved by the document processing device 114. The retrieved schema entries, or templates, are then displayed at step 426 via the web browser associated with the remote client device 128. From this displayed list, the administrative user selects, at step 428, a template schema for modification. At step 430, the selected schema is opened for editing via any means known in the art. The administrative user then modifies the attributes, class relationships, and the like, at step 432, so as to effectuate a modification of the template. The changes are submitted from the remote client device 128 to the server 104, whereupon, at step 434, the modified template is stored, thereby replacing the original template schema and enabling each of the document processing devices 108-114 to access the modified document template. A determination is then made at step 436 whether the administrative user desires to perform any additional operations from the remote client device 128. When additional operations are desired, flow returns to step 404, wherein the determination that the user is an administrative user is made. The method proceeds from there, enabling the administrative user to request a document processing operation or to modify an existing template. When no additional operations are desired at step 436, the remote connection is terminated and the method ends.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for sharing of updated document templates:
a template storage adapted for storing a plurality of document scan templates, each scan template including schema data representative of attributes associated therewith;
means adapted for receiving a plurality of scan templates into the template storage;
a network interface;
means adapted for receiving a scan template request via the network interface;
means adapted for selecting one of the plurality of scan templates in the template storage in accordance with a received scan template request;
means adapted for communicating a selected one of the plurality of scan templates to at least one selected document processing device via the network interface;
means adapted for receiving modification data representative modification of a selected document scan template in the template storage;
means adapted for selectively modifying schema data associated with the selected document scan template in accordance with the modification data; and
means adapted for storing modified schema data in the template storage.

2. The system for sharing of updated document templates of claim 1 wherein the template storage includes a LDAP server.

3. The system for sharing of updated document templates of claim 2 wherein the at least one selected document processing device is comprised of a multi-function peripheral in data communication via the network interface.

4. The system for sharing of updated document templates of claim 1 wherein the modification data is received from an associated user.

5. The system for sharing of updated document templates of claim 4 further comprising:
means adapted for receiving identification data from the associated user;
authentication means adapted for verifying the received identification data so as to determine if the associated user is authorized to modify the schema data associated with the selected document scan template.

6. The system for sharing of updated document templates of claim 5 further comprising means adapted for generating an error signal upon a determination that the user requesting modification of the schema data is not authorized to modify the schema data.

7. The system for sharing of updated document templates of claim 4 wherein the associated user is a system administrator.

8. The system for sharing updated document templates of claim 1 further comprising display means adapted for displaying the plurality of scan templates in the template storage.

9. A method for sharing of updated document templates comprising the steps of:
storing a plurality of document scan templates in a template storage, each scan template including schema data representative of attributes associated therewith;
receiving a plurality of scan templates into the template storage;
receiving a scan template request via a network interface;
selecting one of the plurality of scan templates in the template storage in accordance with a received scan template request;
communicating a selected one of the plurality of scan templates to at least one selected document processing device via the network interface;
receiving modification data representative modification of a selected document scan template in the template storage;
selectively modifying schema data associated with the selected document scan template in accordance with the modification data; and
storing modified schema data in the template storage.

10. The method for sharing of updated document templates of claim 9 wherein the template storage includes a LDAP server.

11. The method for sharing of updated document templates of claim 10 wherein the at least one selected document processing device is comprised of a multi-function peripheral in data communication via the network interface.

12. The method for sharing of updated document templates of claim 9 wherein the modification data is received from an associated user.

13. The method for sharing of updated document templates of claim 111 further comprising the steps of:
receiving identification data from the associated user;
verifying the received identification data so as to determine if the associated user is authorized to modify the schema data associated with the selected document scan template.

14. The method for sharing of updated document templates of claim 13 further comprising means adapted for generating an error signal upon a determination that the user requesting modification of the schema data is not authorized to modify the schema data.

15. The method for sharing of updated document templates of claim 12 wherein the associated user is a system administrator.

16. The method for sharing updated document templates of claim 9 further comprising the step of displaying the plurality of scan templates in the template storage.

17. A computer-readable medium of instructions with instructions stored thereon for sharing of updated document templates comprising the steps of:
instructions for storing a plurality of document scan templates in a template storage, each scan template including schema data representative of attributes associated therewith;
instructions for receiving a plurality of scan templates into the template storage;
instructions for receiving a scan template request via a network interface;
instructions for selecting one of the plurality of scan templates in the template storage in accordance with a received scan template request;
instructions for communicating a selected one of the plurality of scan templates to at least one selected document processing device via the network interface;
instructions for receiving modification data representative modification of a selected document scan template in the template storage;
instructions for selectively modifying schema data associated with the selected document scan template in accordance with the modification data; and
instructions for storing modified schema data in the template storage.

18. The computer-readable medium of instructions with instructions stored thereon for sharing of updated document templates of claim 17 wherein the template storage includes a LDAP server.

19. The computer-readable medium of instructions with instructions stored thereon for sharing of updated document templates of claim 18 wherein the at least one selected document processing device is comprised of a multi-function peripheral in data communication via the network interface.

20. A computer-implemented method for sharing of updated document templates comprising the steps of:
storing a plurality of document scan templates in a template storage, each scan template including schema data representative of attributes associated therewith;
receiving a plurality of scan templates into the template storage;
receiving a scan template request via a network interface;
selecting one of the plurality of scan templates in the template storage in accordance with a received scan template request;
communicating a selected one of the plurality of scan templates to at least one selected document processing device via the network interface;
receiving modification data representative modification of a selected document scan template in the template storage;
selectively modifying schema data associated with the selected document scan template in accordance with the modification data; and
storing modified schema data in the template storage.

21. The computer-implemented method for sharing of updated document templates of claim 20 wherein the template storage includes a LDAP server.

22. The computer-implemented method for sharing of updated document templates of claim 21 wherein the at least one selected document processing device is comprised of a multi-function peripheral in data communication via the network interface.
